(19) United States
(12) Patent Application Publication
(10) Pub. No.: US 2006/0040690 A1
(43) Pub. Date: Feb. 23, 2006

(54) Method of providing PoC service in mobile communication system

(75) Inventors: Se Hee Lee, Songtan-si (KR); Jin Ho Kim, Goyang-si (KR); Sung Chul Yang, Gwangmyeong-si (KR)

Correspondence Address: LEE, HONG, DEGERMAN,;KANG & SCHMADEKA, 801 S. Figueroa Street, 14th Floor, Los Angeles, CA, 90017, US

(73) Assignee: LG Electronics Inc.

(21) Appl. No.: 11/208,094

(22) Filed: Aug. 19, 2005

(30) Foreign Application Priority Data
Aug. 20, 2004 (KR) 10-2004-0065720

(51) Int. Cl. H04B 7/00; H04Q 7/20

(52) U.S. Cl. 455/518; 455/507

(57) ABSTRACT

A method of providing a PoC service service in a mobile communication system is disclosed, by which a user's sensory duration can be reduced in case of switching a status of a traffic channel between a user equipment and a mobile communication network to an active mode from a dormant mode in the mobile communication system such as a CDMA network. The present invention includes a first step of transmitting the PoC service data from a first user equipment in the dormant mode via a short data burst, a second step of allowing the user equipment to enter an active mode via a traffic channel connection after completion of the first step, a third step of transmitting a reception acknowledgement signal (ACK) from a second user equipment having received the PoC service data via the short data burst, and a fourth step of receiving the reception acknowledgement signal (ACK) via a traffic channel.

This application claims the benefit of the Korean Patent Application No. 10-2004-0065720, filed on Aug. 20, 2004, which is hereby incorporated by reference as if fully set forth herein.

### BACKGROUND OF THE INVENTION

1. Field of the Invention

The present invention relates to a method of providing a group communication service in a mobile communication system. Although the present invention is suitable for a wide scope of applications, it is particularly suitable for reducing a user's sensory duration in case of switching a status of a traffic channel between a user equipment and a mobile communication network to an active mode from a dormant mode in the mobile communication system such as a CDMA network.

2. Discussion of the Related Art

Generally, group communications provide an instant messenger service such as a sort of a handie talkie service on a wireless mobile communication system. A group communication service enables instant simple mutual understandings in a manner of pushing a switch to talk as meant by ‘Push-to-Talk’. Hence, in aspect of a duration time, the group communication service can provide a service relatively faster than a general mobile phone.

In case of a group communication service that targets a group, several persons can listen to one user's talking using mobile phones of their own, respectively. Hence, the corresponding group communication service can overcome a limit in one-to-one communications through phones. The group communication service can designate a middle-sized group or enables one-to-one wireless communications, thereby standing in the spotlight of a mobile communication field lately.

FIG. 1 is a block diagram of a system and protocol in implementing a group communication service on a CDMA network.

Referring to FIG. 1, a group communication service providing system consists of user equipments 11 and 19 of users A and B who mutually perform communications and a group communication server 17 connected to the user equipments 11 and 19 via a CDMA network 13 and an Internet network 15.

The user equipments 11 and 19 and the CDMA network 13 uses such a CDMA associated protocol as CDMA-2000, IMT-2000 and the like. And, the user equipments 11 and 19 and the Internet network 15 use such a network protocol as TCP, UDP, IP and the like. Moreover, the user equipments 11 and 19 and the group communication server 17 use such a group communication associated protocol as SIP, RTP and the like.

FIG. 2 is a flowchart for explaining a procedure of an operation in providing a group communication service according to a related art.

Referring to FIG. 2, in order to perform a group communication service between user equipments 11 and 19 of users A and B, a CDMA network 13 should be connected to a CDMA data call (S21), should be connected to an Internet network 15 via a network protocol (S22), and should be connected to a group communication server 17 via a group communication protocol (S23).

If there occurs no data transmission/reception in a CDMA protocol layer, i.e., if no voice or signal is transmitted or received via a data call, the CDMA protocol layer releases the CDMA data call after a prescribed duration and then enters a dormant mode (S24). In this case, ‘releasing the CDMA data call’ means that a connection of a traffic channel is released. And, the dormant mode means a state that a connection between a higher network protocol and a group communication protocol layer is maintained although a connection in a CDMA section is released. The dormant mode is similar to a structure that a user can keep reading an article downloaded via wireless Internet despite a substantial disconnection of a CDMA call after a prescribed duration in using wireless Internet service or the like.

In doing so, if data to be transmitted is generated from a higher layer of CDMA, i.e., a network layer or group communication layer, the CDMA call is re-connected by attempting a connection of the CDMA layer only (S25). The user equipment transmits the data via the connected CDMA data call (S26) and then receives acknowledgement ACK from a receiving side (S27). In this case, one thing differing from an initial connection attempt by turning on power is that the group communication layer and the network layer need not to be re-connected via initialization and negotiation.

However, in the related art, in case of exchanging messages or data generated from the group communication layer in the dormant mode, the CDMA call needs to be connected once despite a size of the message or data. Hence, it takes about 1.8 second to connect the CDMA call, which makes a user feel that a delay of data transmission/reception takes place.

### SUMMARY OF THE INVENTION

Accordingly, the present invention is directed to a method of providing a group communication service in a mobile communication system that substantially obviates one or more problems due to limitations and disadvantages of the related art.

An object of the present invention is to provide a method of providing a group communication service in a mobile communication system, by which a user's sensory duration can be reduced in case of switching a status of a traffic channel between a user equipment and a mobile communication network to an active mode from a dormant mode in the mobile communication system such as a CDMA network.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of providing a group communication service in a mobile communication system, which sustains a dormant mode due to non-presence of group communication data transmitted for a predetermined time, according to the present invention includes a first step of transmitting the group communication data from a first user equipment in the dormant mode via a short data burst, a second step of allowing the user equipment to enter an active mode via a traffic channel connection after completion of the first step, a third step of transmitting a reception acknowledgement signal (ACK) from a second user equipment having received the group communication data via the short data burst, and a fourth step of receiving the reception acknowledgement signal (ACK) via a traffic channel.

Preferably, the method further includes the step of re-establishing a connection of the traffic channel right after or the moment the third step is executed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a system and protocol in implementing a group communication service on a CDMA network;

FIG. 2 is a flowchart for explaining a procedure of an operation in providing a group communication service according to a related art; and

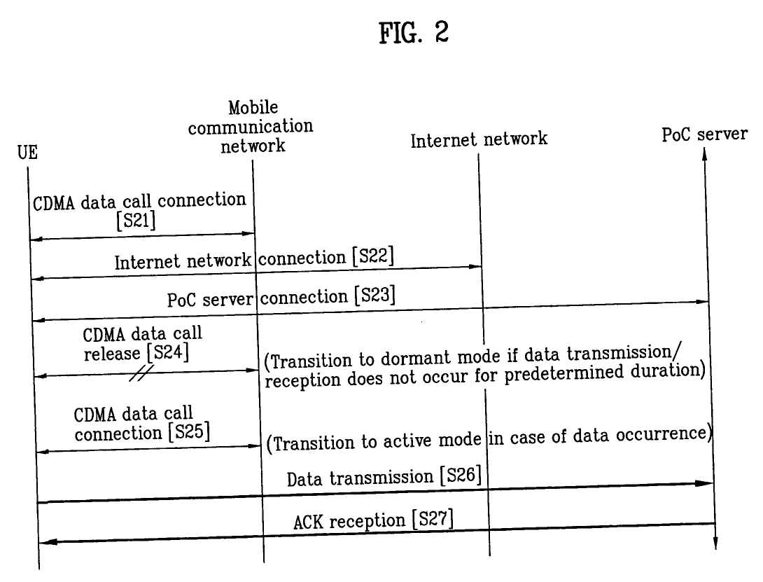

FIG. 3 is a flowchart of a method of providing a group communication service in a mobile communication system according to one preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

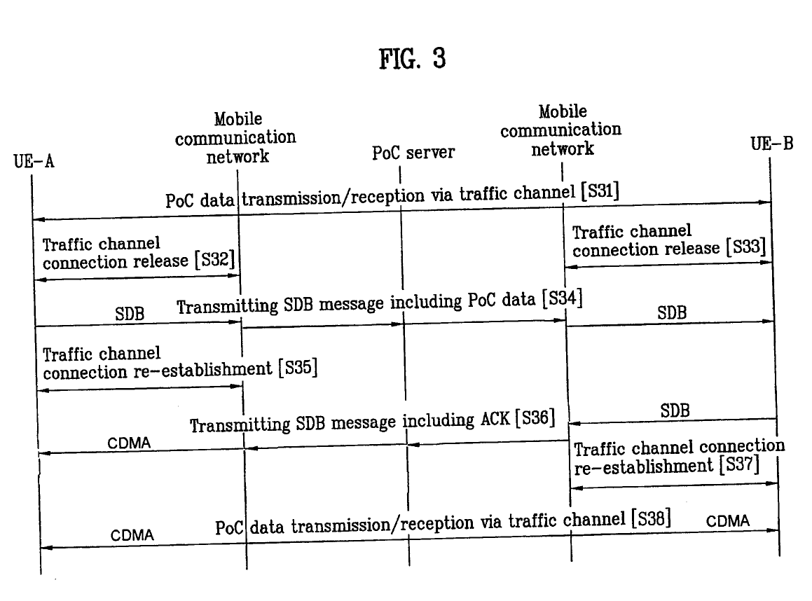

FIG. 3 is a flowchart of a method of providing a group communication service in a mobile communication system according to one preferred embodiment of the present invention.

In the embodiment shown in FIG. 3, it is assumed that user equipments A and B make mutual communications via a one-to-one group communication service. This is just for convenience of explanation. Since a group communication service enables group communications, it is apparent to those skilled in the art that the scope of the present invention is not limited to the embodiment shown in FIG. 3.

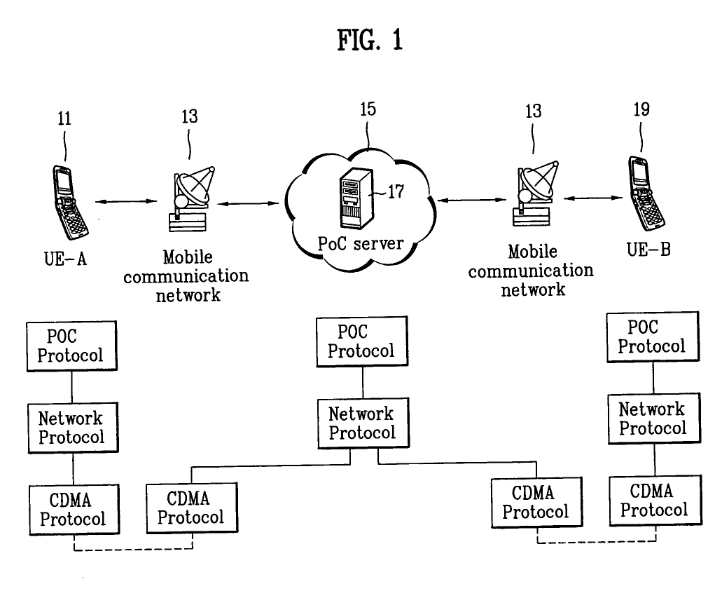

First of all, in order to provide a group communication service, data processing and transmission procedures by the group communication, network and CDMA protocols, as shown in FIG. 1, need to be done. The procedures are explained in detail as follows.

Once a user of the user equipment A inputs a voice via an application supporting a group communication service, a group communication entity of the user equipment A processes data according to the group communication protocol and then delivers the corresponding result to a network layer that is a lower layer. In case of Internet, the network layer includes TCP (or UDP), IP and the like. In the network layer, the data delivered from the group communication protocol entity is processed according to the TCP (or UDP) and IP and the processed data is then delivered to a CDMA layer that is a lower layer. In the CDMA layer, the data delivered from the network layer is processed according to a CDMA protocol to be transmitted via a mobile communication network. The data transmitted via the mobile communication network passes through Internet to be transmitted to a group communication server. The data received by the group communication server is processed according to a group communication protocol to be transmitted to the user equipment B via a process reverse to the transmission process between the user equipment A and the group communication server.

In the data communication process via the group communication service, the present invention is characterized in being associated with the data processing and transmission processes by the CDMA protocol between the user equipment A and the mobile communication network or between the mobile communication network and the user equipment B.

A data transmission between a user equipment and a mobile communication network in a mobile communication system is carried out by a traffic channel and a control channel. The traffic channel carries traffic data such as voice data, multimedia data and the like. And, the control channel carries control information to play a role in sustaining and maintaining an interface or call of the mobile communication network.

Hence, in order for the user equipment to exchange data via the mobile communication network, connections of the traffic and control channels should be established. The traffic channel differs from the control channel in a following way. First of all, in case of the traffic channel, if there exists no data to be transmitted for a predetermined duration while the connection is established, the connection is released. Yet, in case of the control channel, even if there exists no data transmission for a predetermined duration, the connection is sustained instead of being released. If a data transmission reoccurs after the connection of the traffic channel has been released, a connection should be re-established. In the process of re-establishing the connection, a delay amounting to a predetermined duration time takes place.

Referring to FIG. 3, in performing a data transmission between the user equipments A and B via the group communication service, group communication data are initially transmitted and received via traffic channels between the user equipment A and the mobile communication network and between the mobile communication network and the user equipment B, respectively (S31).

In case that there occurs no data transmission for a predetermined time, the connection of the traffic channel between the user equipment A and the mobile communication network and the connection of the traffic channel between the mobile communication network and the user equipment B are released (S32, S33). Even if the connections of the traffic channels are released, connections of control channels between the user equipment A and the mobile communication network and between the mobile communication network and the user equipment B keeps being sustained instead of being released.

To transmit the data (hereinafter called ‘group communication data’) processed by the group communication protocol and the network protocol to the mobile communication network by the CDMA protocol while the connection of the traffic channel is released, a connection of the traffic channel should be re-established. Yet, since it takes about 1.8 second to re-establish the connection of the traffic channel, users of the group communication service feel inconvenience due to the delayed duration.

In the present invention, to reduce the sensory delay time due to the re-establishment of the traffic channel, group communication data is included in a specific message, which is transmitted via the control channel established between the user equipment A or B and the mobile communication network, to be transmitted (S34).

Preferably, a volume of the group communication data included in the specific message transmitted via the control channel is set small. For instance, the user of the user equipment A firstly transmits data via the group communication service and stops transmitting the data. If the user presses a call button of the user equipment A to transmit the data again, the group communication protocol entity of the user equipment A transmits a message ‘INVITE’ to the PoC server. And, the corresponding small volume of data can be included in the specific message transmitted via the control channel to be transmitted. Meanwhile, in the current PoC protocol standard, it is taken as a basic principle to transmit text-based data. Yet, a volume of the text-based data is considerably large. Hence, the text-based PoC service data is preferably converted to binary data to be included in the specific message.

In the embodiment of the present invention described in FIG. 3, the specific message includes a short data burst (SDB) message in the CDMA-2000 mobile communication system. Moreover, the specific message can include one of various messages such as an SMS message in which the PoC service data can be included.

The PoC service data is included in the specific message transmitted via the control channel, e.g., SDB message. Right after or the moment the specific message including the PoC service data is transmitted, a connection of the traffic channel between the user equipment A and the mobile communication network is re-established (S35).

The user equipment B having received the PoC service data included in the SDB message includes a signal ‘ACK’ of acknowledging the reception of the PoC service data in the SDB message and then transmits the corresponding message via the control channel (S36).

Right after or the moment the signal ‘ACK’ is transmitted, a connection of the traffic channel between the mobile communication network and the user equipment B is re-established (S37). After the connections of the traffic channels between the user equipment A and between the mobile communication network and the user equipment B have been re-established, respectively, the PoC service data can be transmitted via the traffic channels (S38).

In the above-explained embodiment of the present invention, the CDMA wireless mobile communication system is taken as an example. And, the technical features of the present invention are also applicable to a wireless mobile communication system utilizing a different wireless access technology such as TDMA, FDMA and the like.

Accordingly, in the PoC service providing method in the mobile communication system, the present invention shortens the connection time taken to transmit the PoC service data while the connection of the traffic channel is released in providing the PoC service. Therefore, the present invention can reduce the delayed duration sensed by a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of providing a PoC Push-to talk over Communication service in a mobile communication system, the method comprising:
transmitting the PoC service data from a first user equipment to a second user equipment via a first short data burst;
re-establishing a traffic channel at the first user equipment;
transmitting a acknowledgement signal (ACK) response to the PoC service data from the second user equipment to a PoC (Push-to talk over communication) server via a second short data burst; and
transmitting the acknowledgement signal (ACK) via the traffic channel from the PoC server to the first user equipment.

2. The method of claim 1, further comprising the step of allowing the first user equipment to enter an active mode via a connection of the traffic channel.

3. The method of claim 1, further comprising the step of re-establishing another traffic channel at the second user equipment.

4. The method of claim 1, wherein the first and second short data burst are included by a control channel.

5. The method of claim 1, wherein at least one of the first and second user equipment is in dormant mode.

6. The method of claim 1, wherein the PoC service data is used for group communication.
